(19) United States
(12) Patent Application Publication
(10) Pub. No.: US 2011/0123706 A1
(43) Pub. Date: May 26, 2011

(54) CONTINUOUS COATING SUPPLY SYSTEM AND METHOD

(75) Inventors: Chen-Hsing CHENG, Tu-Cheng (TW); Tsung-Yu HUNG, Tu-Cheng (TW); Ching-Ho WEI, Tu-Cheng (TW)

(73) Assignee: HON HAI PRECISION INDUSTRY CO., LTD., Tu-Cheng (TW)

(21) Appl. No.: 12/650,574

(22) Filed: Dec. 31, 2009

(30) Foreign Application Priority Data
Nov. 25, 2009 (TW) 98140024

(51) Int. Cl. B05D 1/02; B05C 11/00

(52) U.S. Cl. 427/8; 118/694; 427/421.1

(57) ABSTRACT

A continuous coating supply system includes a first coating storage unit, a second coating storage unit, a coating intake, a coating outlet, conduits and a plurality of valves. The conduits connect the first storage unit, the second coating storage unit, the coating intake and the coating outlet and are positioned on the conduits. The control unit is respectively connected to the first storage unit and the second storage, to determine a volume of coating in the first storage unit and the second storage unit, thus deciding to opened and close the valves. The pressure unit is respectively connected to the first storage unit and the second storage unit, to apply air pressure to the first coating storage unit and the second coating storage unit.

### BACKGROUND

1. Technical Field

The present disclosure relates generally to supply systems used in manufacturing and, more particularly, to a continuous coating supply system for liquid coating material such as ink.

2. Description of Related Art

A portable electronic device, such as a mobile phone, generally has a housing for protecting inner electrical components. The housing is often coated for protective and decorative purposes. In manufacturing of the housing, a spray apparatus is typically used to apply the coating. The coating is typically paint or ink. The spray apparatus has an associated coating storage unit for holding the coating material in readiness for use. When the coating storage unit becomes empty, the coating storage unit is removed from the spray apparatus for refilling.

However, workpieces such as housings to be coated are continuously supplied in a painting process, and thus the spray apparatus is required to continuously operate. If the coating storage unit becomes empty unexpectedly, some workpieces may not be coated sufficiently or uniformly. In addition, regular removal of the coating storage unit for refilling reduces the efficiency of the painting process.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an embodiment of a continuous coating supply system.

FIG. 2 is a flowchart of an embodiment of an exemplary method of continuous coating supply.

### DETAILED DESCRIPTION

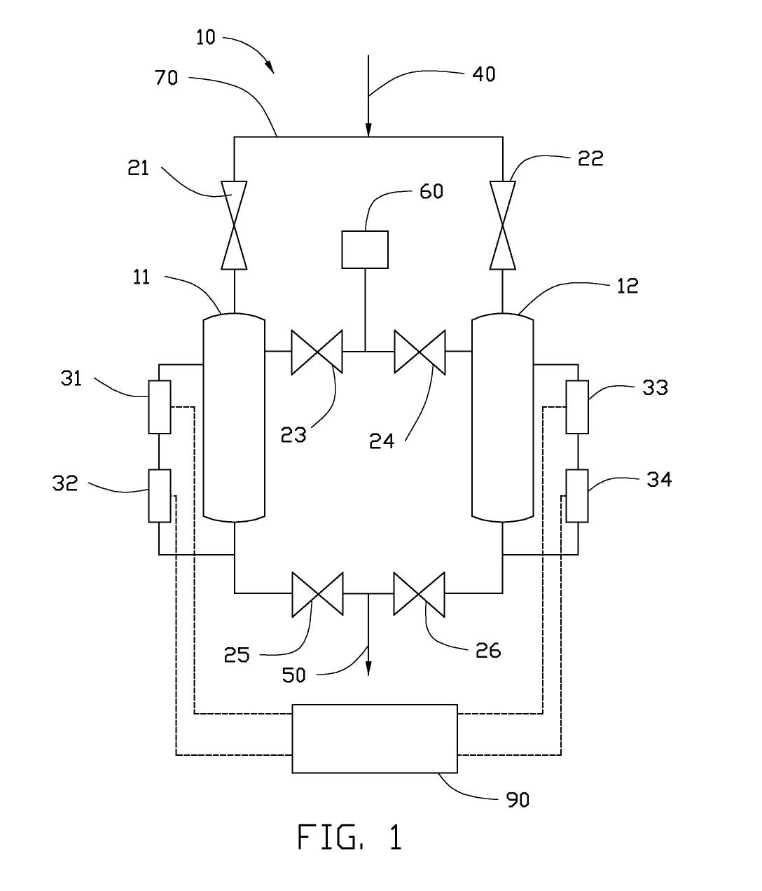

Referring to FIG. 1, a first embodiment of a continuous coating supply system 10 includes a first coating storage unit 11, a second coating storage unit 12, a coating intake 40, a coating outlet 50, a first valve 21, a second valve 22, a third valve 23, a fourth valve 24, a fifth valve 25, a sixth valve 26, a control unit (not labeled), a pressure unit 60, and a plurality of conduits 70. The first coating storage unit 11 and the second coating storage unit 12 are arranged side by side and respectively connected to the coating intake 40, the coating outlet 50 and the pressure unit 60 via the conduits 70. In the illustrated embodiment, the control unit includes a first high liquid level sensor 31, a first low liquid level sensor 32, a second high liquid level sensor 33, a second low liquid level sensor 34, and a processor 90. The first high liquid level sensor 31 and the first low liquid level sensor 32 are connected to the first coating storage unit 11. The second high liquid level sensor 33 and the second low liquid level sensor 34 are connected to the second coating storage unit 12. The first low liquid level sensors 31, the first low liquid level sensor 32, the second high liquid level sensor 33, and the second low liquid level sensor 34 are respectively electrically connected to the processor 90. The control unit is configured for sensing a volume of coating in the first coating storage unit 11 or the second coating storage unit 12, and regulates opening and closing of the valves 21, 22, 23, 24. The first valve 21, the second valve 22, the third valve 23, the fourth valve 24, the fifth valve 25 and the sixth valve 26 are pneumatic valves.

The first valve 21 is positioned on the conduit 70 connecting the first coating storage unit 11 to the coating intake 40. The third valve 23 is positioned on the conduit 70 connecting the first coating storage unit 11 to the pressure unit 60. The fifth valve 25 is positioned on the conduit 70 connecting the first coating storage unit 11 to the coating outlet 50. The second valve 22 is positioned on the conduit 70 connecting the second coating storage unit 12 to the coating intake 40. The fourth valve 24 is positioned on the conduit 70 connecting the second coating storage unit 12 to the pressure unit 60. The sixth valve 26 is positioned on the conduit 70 connecting the second coating storage unit 12 to the coating outlet 50. The continuous coating supply system 10 further includes a sprayer (not shown) connected to the coating outlet 50.

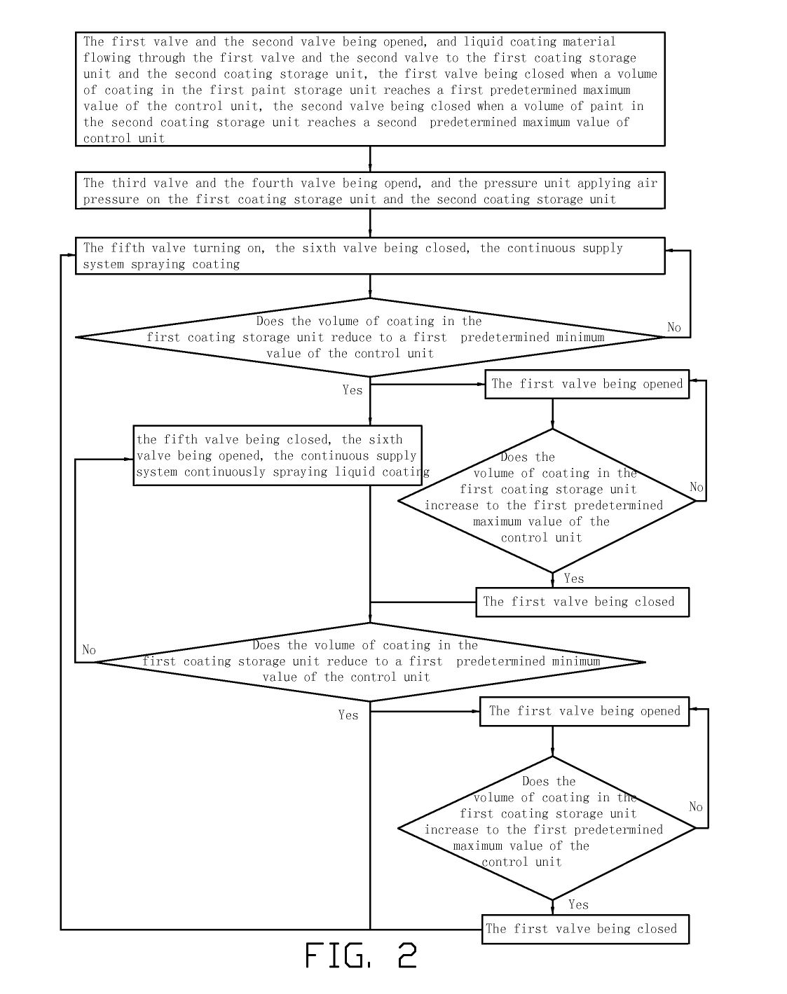

FIG. 2 summarizes an exemplary continuous coating supplying method using a continuous coating supply system, such as, for example, the continuous coating supply system 10. The method is as follows:

In a first step, the first valve 21 and the second valve 22 are opened, and liquid coating material flows through the first valve 21 and the second valve 22 and fills the first coating storage unit 11 and the second coating storage unit 12. When a volume of the liquid coating in the first coating storage unit 11 reaches a first predetermined maximum value of the first high liquid level sensor 31, the first valve 21 is closed, under control of the processor 90. When a volume of the liquid coating in the second coating storage unit 12 reaches a second predetermined maximum value of the second high liquid level sensor 33, the second valve 22 is closed, under control of the processor 90.

In a second step, the third valve 23 and the fourth valve 24 are opened under control of the processor 90, and the pressure unit 60 applies air pressure to the first coating storage unit 11 and the second coating storage unit 12.

In a third step S3, the fifth valve 25 is opened, under control of the processor 90, and liquid coating in the first coating storage unit 11 flows through the fifth valve 25, and spraying commences.

In a fourth step, when the volume of liquid coating in the first coating storage unit 11 reaches a first predetermined minimum value of the first low liquid level sensor 33, the fifth valve 25 is closed and the sixth valve 26 is opened, under control of the processor 90. The first coating storage unit 11 stops supplying liquid coating, and liquid coating in the second coating storage unit 12 flows through the sixth valve 26 to the coating outlet 50. Thus, the continuous coating supply system 10 provides a continuous source of liquid coating for uninterrupted spraying. The first valve 21 is opened again under control of the processor 90, and outside liquid coating flows through the coating intake 40 and the first valve 21, and fills the first coating storage unit 11. The first valve 21 is closed again when the volume of liquid coating in the first coating storage unit 11 reaches the first predetermined maximum value of the first high liquid level sensor 31.

In a fifth step S5, when the volume of liquid coating in the second coating storage unit 12 reaches a second predetermined minimum value of the second low liquid level sensor 34, the sixth valve 26 is closed and the fifth valve 25 is opened, under control of the processor 90. The second coating storage unit 12 stops supplying liquid coating, and liquid coating in the first coating storage unit 11 flows through the fifth valve 25 to the coating outlet 50. Thus the continuous coating supply system 10 provides a continuous source of liquid coating for uninterrupted spraying. The second valve 22 is opened again under control of the processor 90, and outside liquid coating flows through the coating intake 40 and the second valve 22, and fills the second coating storage unit 12. The second valve 22 is closed again when the volume of liquid coating in the second coating storage unit 12 reaches the second maximum predetermined value of the second high liquid level sensor 33.

In a sixth step, the third step, the fourth step and the fifth step are repeated, such that the continuous supply system 10 provides a continuous source of liquid coating for uninterrupted spraying.

The continuous coating supply system 10 utilizes the first coating storage unit 11 and the second coating storage unit 12 to alternately supply liquid coating, and the first coating storage unit 11 and the second coating storage unit 12 are alternately refilled, whereby the continuous coating supply system 10 functions without interruption.

It should be pointed out that the liquid level sensors 31, 32, 33 and 34 can be replaced by other measuring components, such as resistance sensors. The valves 21, 22, 23, 24, 25 and 26 can be manual or electric. In addition, the continuous coating supply system 10 may include more than two coating storage units electrically connected to the control unit, such that the continuous coating supply system 10 can provide a continuous source of liquid coating for uninterrupted spray.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A continuous coating supply system, comprising:
a first coating storage unit and a second coating storage unit;
a coating intake and a coating outlet;
a plurality of conduits;
a plurality of valves positioned on the conduits;
a control unit respectively connected to the first coating storage unit and the second coating storage unit, and configured to, based on a measured volume of liquid coating in the first coating storage unit and the second coating storage unit, selectively open and close the valves to communicate the coating outlet with the first coating storage unit and the second coating storage unit alternately; and
a pressure unit respectively connected to the first coating storage unit and the second coating storage unit, and configured to apply air pressure to the first coating storage unit and the second coating storage unit;
wherein the conduits connect the first coating storage unit, the second coating storage unit, the coating intake, the pressure unit, and the coating outlet together.

2. The continuous coating supply system of claim 1, wherein the plurality of valves comprises six valves, the plurality of conduits comprises six conduits, a first one of the valves is positioned on a first one of the conduits between the coating intake and the first coating storage unit, a second one of the valves is positioned on a second one of the conduits between the coating intake and the second coating storage unit, a third one of the valves is positioned on a third one of the conduits between the pressure unit and the first coating storage unit, a fourth one of the valves is positioned on a fourth one of the conduits between the pressure unit and the second coating storage unit, a fifth one of the valves is positioned on a fifth one of the conduits between the first coating storage unit and the coating outlet, and a sixth one of the valves is positioned on a sixth one of the conduits between the second coating storage unit and the coating outlet.

3. The continuous coating supply system of claim 1, wherein the control unit comprises a first high liquid level sensor and a first low liquid level sensor connected to the first coating storage unit, a second high liquid level sensor and a second low liquid level sensor connected to the second coating storage unit, and a processor electrically connected to the first high liquid level sensor, the first low liquid level sensor, the second high liquid level sensor and the second low liquid level sensor.

4. The continuous coating supply system of claim 3, wherein the valves are pneumatic valves.

5. The continuous coating supply system of claim 1, wherein the first coating storage unit and the second coating storage unit are arranged side by side.

6. A method for continuous coating supply, the method comprising:
providing a continuous coating supply system, comprising:
a first coating storage unit and a second coating storage unit;
a coating intake and a coating outlet;
a plurality of conduits;
a plurality of valves positioned on the conduits;
a control unit respectively connected to the first coating storage unit and the second coating storage unit;
a pressure unit respectively connected to the first coating storage unit and the second coating storage unit;
wherein the conduits connect the first coating storage unit, the second coating storage unit, the coating intake, the pressure unit, and the coating outlet together;
filling the first coating storage unit and the second coating storage unit with liquid coating via the coating intake;
the pressure unit applying air pressure on the first coating storage unit and the second coating storage unit;
the first coating storage unit fluidly communicating with the coating outlet, such that the continuous coating supply system can start spray operations;
when a volume of liquid coating in the first coating storage unit reaches a first predetermined minimum value, the first coating storage unit disconnecting from the coating outlet, and the second coating storage unit fluidly communicating with the coating outlet such that the spraying operations can continue uninterrupted, the first coating storage unit fluidly recommunicating with the coating intake and liquid coating thereby filling the first coating storage unit, and when the volume of liquid coating in the first coating storage unit reaches a first predetermined maximum value, the first coating storage unit disconnecting from the coating intake;
when a volume of liquid coating in the second coating storage unit reaches a second predetermined minimum value, the second coating storage unit disconnecting from the coating outlet, and the first coating storage unit fluidly recommunicating with the coating outlet such that the spraying operations can continue uninterrupted, the second coating storage unit fluidly recommunicating with the coating intake and liquid coating thereby filling the second coating storage unit, and when the volume of liquid coating in the second coating storage unit reaches a second predetermined maximum value, the second coating storage unit disconnecting from the coating intake.

7. The method for continuous coating supply of claim 6, wherein the fluid communications, the disconnections, and the fluid recommunications are implemented by the respective applicable valves.

8. The method for continuous coating supply of claim 6, wherein the control unit comprises a first high liquid level sensor and a first low liquid level sensor connected to the first coating storage unit, a second high liquid level sensor and a second low liquid level sensor connected to the second coating storage unit, and a processor electrically connected to the first high liquid level sensor, the first low liquid level sensor, the second high liquid level sensor and the second low liquid level sensor.

9. The method for continuous coating supply of claim 6, wherein the valves are pneumatic valves.

10. The method for continuous coating supply of claim 6, wherein the first coating storage unit and the second coating storage unit are arranged side by side.
